(19) United States
(12) Patent Application Publication
(10) Pub. No.: US 2010/0282962 A1
(43) Pub. Date: Nov. 11, 2010

(54) INTRODUCTION OF ADDITIVES FOR AN IONIZATION INTERFACE AT ATMOSPHERIC PRESSURE AT THE INPUT TO A SPECTROMETER

(75) Inventors: Xavier Machuron-Mandard, Massy (FR); Olivier Vigneau, Antony (FR)

Correspondence Address: Nixon Peabody LLP, P.O. Box 60610, Palo Alto, CA, 94306, US

(73) Assignee: COMMISSARIAT A L'ENERGIE ATOMIQUE, Paris (FR)

(21) Appl. No.: 12/161,539

(22) PCT Filed: Jan. 19, 2007
(86) PCT No.: PCT/EP07/50553

§ 371 Date: Jul. 18, 2008

(30) Foreign Application Priority Data
Jan. 20, 2006 (FR) 06 50209

(51) Int. Cl. H01J 49/04; H01J 49/26

(52) U.S. Cl. 250/282; 250/288

(57) ABSTRACT

This invention relates introduction of at least one additive for the analysis of at least one substance of interest using a mass spectrometer or an ion mobility spectrometer. The substance to be analyzed is injected through an API interface. The additive is introduced by adding spray gas.

### CROSS REFERENCE TO RELATED APPLICATIONS or PRIORITY CLAIM

This application is a national phase of International Application No. PCT/EP2007/050553, entitled “INTRODUCTION OF ADDITIVES FOR AN ATMOSPHERIC-PRESSURE IONIZATION INTERFACE TO THE INLET OF A SPECTROMETER”, which was filed on Jan. 19, 2007, and which claims priority of French Patent Application No. 06 50209, filed Jan. 20, 2006.

### DESCRIPTION

1. Technical Domain

This invention relates to the domain of ion spectrometry. In particular, it relates to the introduction of additives for an ionization interface at atmospheric pressure, at the input to a mass spectrometer or an ion mobility spectrometer. These additives are designed to facilitate the identification of substances of interest and to increase the sensitivity of the detector to these products.

2. State of Prior Art

Development of interfaces such as API (<<Atmospheric Pressure Ionization>>) that includes (ESI<<ElectroSpray Ionization>>), APCI (<<Atmospheric Pressure Chemical Ionization>>) and APPI (<<Atmospheric Pressure Photo Ionization>>), has made it possible to analyze liquid samples containing various substances by mass spectrometry and by ion mobility spectrometry (IMS). The fundamental problem that arises in mass spectrometry is the inability of the spectrometer to absorb all solvent vapors originating from evaporation of the eluant. This eluant may for example originate from a chromatographic system (HPLC), a capillary electrophoresis system or direct infusion of a solution. ESI, APCI and APPI are capable of reducing the pressure from approximately atmospheric pressure to a pressure of the order of 10⁻⁹ bars (pressure inside the mass spectrometer). The ion mobility spectrometer is dedicated mainly to vapor analysis. However, recent work describes the integration of an API interface to enable analysis of liquid samples originating from a chromatographic column, a capillary electrophoresis or direct injection into the interface. Further information on this subject is given in the articles by D. WITTMER et al., “Electrospray Ionization Ion Mobility Spectrometry”, Analytical Chemistry 66 (1994), pages 2 348 to 2 355, and by C. WU et al., “Electrospray Ionization High-Resolution Ion Mobility Spectrometry-Mass Spectrometry”, Analytical Chemistry 70 (1998), pages 4 929 to 4 938. API interfaces are considered to be mild ionization methods.

Electrospray ionization (ESI) is a process capable of generating ions using an intense electric field. An intense electric potential is applied at the output from the capillary tube in which the eluant is flowing from the chromatographic column. This electric field, associated with application of a spraying gas (for example possibly nitrogen or air) causes the formation of a cloud of droplets charged on the surface simultaneously passing through a pressure gradient and an electric potential gradient. The size of the droplets reduces due to evaporation of the solvent, Coulomb repulsion forces become increasingly intense and cause an explosion of the droplets into smaller droplets. These successive explosions cause the formation of desolvated ions in the gaseous phase. These ionized species are then directed towards the analyzer.

Ionization by an APCI interface is based on chemical ionization. The eluant flows in a quartz tube in which a spray gas circulates. An auxiliary gas and a heating block are used so as to guarantee a fast and efficient change of the solvent and the molecules present into the gas state. A metallic needle (corona needle) with a potential of a few kilovolts relative to the instrument ground is placed close to the tube output. Solvent vapors are ionized by the corona discharge and they subsequently react with products present in the gas phase. In positive mode, nitrogen is usually used as a spray gas. In negative mode, nitrogen can be replaced by air.

In the context of the APPI interface, the ionization is done by photons rather than by a corona discharge as is the case for the APCI. These photons are generated by a UV lamp and enable ionization of molecules present in the gas phase.

Ionization through the API interface is applicable equally well for acid or basic compounds and for only slightly ionizable molecules. This ionization technique frequently leads to the observation of positive or negative adducts as a function of products present in the eluant and/or in the sample. These adducts may be obtained accidentally (for example due to the presence of sodium ions, particularly when methanol is used as the eluant) or intentionally to obtain better sensitivity or more specific detection.

In the case of ionization in positive mode (the ions formed are positively charged), the addition of sodium, potassium or ammonium based products, or others products (such as acids) is used to form adducts. When ionization takes place in negative mode, organic solvents (such as chloroform, dichloromethane, etc.) or salts based on chlorides (ammonium chloride, sodium chloride, etc.) or acetates (ammonium acetate, etc.) are used. However, it is preferable to use volatile compounds so as to avoid sensitivity losses due to elimination of ionization and dirt accumulation in the instrument (ionization chamber, mass spectrometer and ion mobility spectrometer).

Adducts are often used either in positive mode or negative mode because they enable a gain of sensitivity for only slightly ionizable compounds and for compounds that produce multiple ions (thus limiting the performances of the quantitative analysis).

S. GAO et al., in the “Sensitivity Enhancement in Liquid Chromatography/Atmospheric Pressure Ionization Mass Spectrometry Using Derivatization and Mobile Phase Additives” article, Journal of Chromatography B, Vol. 825, Number 2, 25 Oct. 2005, pages 98 to 110, describes the main additives that can be used in mobile phases in chromatography to increase the sensitivity to HPLC-MS. Additives vary as a function of the nature of the ions to be detected (positive ions or negative ions). Thus, basic compounds (for example amines) can be analyzed using acetic acid (pH between 3 and 4), formic acid (pH between 2 and 3) and trifluoroacetic acid (pH between 1 and 2) to form adducts for detection in positive ions. Compounds with a carboxylic function (for example carboxylic acids) can be analyzed using ammonium hydroxide to form negatively ionized adducts. An alkaline salt or other metal salts (Na⁺, K⁺, Li⁺, etc.) can be used to analyze other products that can form positive adducts (for example nitramines, phenols). Cl⁻, Br⁻, F⁻, CN⁻, etc., can be used to form negative adducts.

Adducts are used in mass spectrometry to improve detection and to obtain structural information as in the case of fullerenes (see G. KHAIRALLAH et al., “Cyano Adduct Anions of Higher Fullerenes: Electrospray Mass Spectrometric Studies” in the International Journal of Mass Spectrometry 194 (2000), pages 115 to 120), or polychlorinated paraffins (see Z. ZENCAK et al., “Analysis of Chlorinated Paraffins by Chloride Enhanced APCI-MS” in Organohalogen Compounds, 66 (2004), pages 310 to 314), or phenols (see Y. CAI et al., “Stabilization of Anionic Adducts in Negative Ion Electrospray Mass Spectrometry” in Analytical Chemistry, 74 (2002), pages 985 to 991) and sugars (see Y. CAI et al., “Evaluation of the Role of Multiple Hydrogen Bonding in Offering Stability to Negative Ion Adducts in Electrospray Mass Spectrometry” in Journal of the American Society for Mass Spectrometry, 13 (2002), pages 1 360 to 1 369).

In the case of sugars, J. ZHU et al., in the article “Formation and Decomposition of Chloride Adduct Ions, {M+Cl}⁻, in Negative Ion Electrospray Ionization Mass Spectrometry”, Journal of the American Society for Mass Spectrometry, 11 (2000), pages 932 to 941, introduced lithium chloride during the preparation of samples containing various monosaccharides and oligosaccharides. The affinity of chloride ions for saccharides induces predominance of [M+Cl]⁻ ions during analyses made using a mass spectrometer provided with an electrospray source. Mass spectrometry in tandem with the formation of chlorinated adducts made it possible to explain the structures of oligosaccharides. H. LIANG et al., in the “Sensitive and Selective LC/MS/MS Method for Determination of Endogenous Polyols in Human Nerve Tissues” article, 2004, ASMS Conference, Nashville, Tenn., USA, pages 1 to 9, demonstrated the advantage of chlorinated solvents for detection and identification of sugars (such as fructose and sorbitol) in HPLC/MS and in HPLC/MS/MS. They compared the introduction of chlorinated products (such as dichloromethane, chloroform, carbon tetrachloride or 1-chlorobutane), by a post-column system and by addition in the mobile phase. It was found that the addition of dichloromethane in the mobile phase provided a means of obtaining a better signal-to-noise ratio and the best reproducibility in the analysis of sugars by HPLC/MS/MS using an APCI interface in negative made.

Ion mobility spectrometers are dedicated mainly to the analysis of gas samples. Further information about this subject can be obtained in articles by C. L. RHYKERD et al., “Guide for the Selection of Commercial Explosive Detection Systems for Law Enforcement Applications”, NIJ Guide 100-99, US Department of Justice, National Institute of Justice, 1999, and by Y. YINON et al., “Modern Methods and Applications in Analysis of Explosives”, John WILEY & Sons, ISBN 0471965626, Eastbourne, United Kingdom.

Thus, in order to improve detection of ethylene glycol dinitrate (EGDN) present in a gas sample, C. J. PROCTOR et al. introduced an additional gas containing traces of dichloromethane into the vector gas. This system is only used for compounds present in the gas phase (see the article “Alternative Reagent Ions for Plasma Chromatography”, Analytical Chemistry, 56 (1984), pages 1 794 to 1 797). However, as demonstrated by the authors of the first two articles mentioned (D. WITTNER et al. and C. WU et al.), it is possible to integrate an API interface into an ion mobility spectrometer to analyze liquid samples that can originate from a chromatographic column, capillary electrophoresis or a direct introduction system (by infusion). In this case, the addition of gas containing traces of additives is not as easy. The use of salts (sodium chloride, ammonium chloride, ammonium acetate, etc.) is common. During the analysis of liquid samples containing nitramines (HMX and RDX), G. R. ASBURY et al. (see the article “Analysis of Explosives Using Electrospray Ionization/Ion Mobility Spectrometry (ESI/IMS)”, Talanta 50 (2000), pages 1 291 to 1 298) introduced sodium chloride into samples so as to enable the formation of [M+Cl]⁻ ions. As above, these adducts were used to improve detection by ion mobility spectrometry. The detection limits indicated were equal to 45 and 21 pg respectively. It is highly probable that sodium chloride causes dirt accumulation and corrosion of the spectrometer.

In order to improve the sensitivity of ESI-IMS towards explosives, M. TAM et al. (see the article “Secondary Electrospray Ionization-Ion Mobility Spectrometry for Explosive Vapor Detection”, Analytical Chemistry, 76 (2004), pages 2 741 to 2 747) developed a secondary electrospray ionization (SESI) method, enabling them to use non-volatile additives that they introduce into the eluant injected into the electrospray source so as to form adducts [M+Cl]⁻. The sample, previously vaporized using an additional gas, is not introduced into the electrospray source but is introduced into the desolvatation zone of the ion mobility spectrometer. A slight improvement in sensitivity is obtained for the RDX contained in aqueous samples, compared with an analysis done by ESI-IMS. It is also possible to couple a mass spectrometer to ESI-IMS in order to obtain information about the mass of the detected ions. Further information about this subject is given in the second article (C. WU et al.) and the article by B. H. CLOWERS et al., “Mass Analysis of Mobility-Selected Ion Populations Using Dual Gate, Ion Mobility, Quadrupole Ion Trap Mass Spectrometry”, Analytical Chemistry, 77 (2005), pages 5 877 to 5 885.

However, note that these additives can only be added in small concentrations to avoid phenomena such as an increase in the background noise, elimination of ionization and dirt accumulation in the ionization chamber of the mass spectrometer and the ion mobility spectrometer (see N. B. CECH et al., “Practical Implications of some Recent Studies in Electrospray Ionization Fundamentals”, Mass Spectrometry Reviews 20 (2001), pages 362 to 387). Furthermore, in the case of chromatographic systems, salts dramatically contaminate the equipment (column, degasser, pipework). Further information about this subject is given in the article by S. KROMIDAS entitled “More Practical Problem Solving in HPLC”, Wiley-VCH, ISBN 3527311130, 2005. An alternative is to introduce the additives directly into the sample before their chromatographic separations. Apart from the fact that these additives can contaminate samples and could be the source of error and dilution, they are usually not selected by chromatographic columns and are quickly eluated. Their concentration in the atmosphere of the ionization chamber is not constant as a result and consequently they can cause a major loss of sensitivity and reproducibility for compounds of interest most frequently selected by the chromatographic column. In this case, the adduct formed is not optimal. Ideally, the eluant introduced into the ionization chamber should be regulated in terms of time and concentration of additives, so as to obtain an intimate mix between the eluant and the additive. Post column systems can then be used but these processes usually lead to an increase in elution bands and a dilution of the sample.

Z. ZENCAK et al. have used chlorinated adducts to improve the selectivity and the sensitivity of the analysis of the mix of polychlorinated n-alkanes. These analyses were carried out by CG-MS (see Z. ZENCAK et al., “Dichloromethane-Enhanced Negative Ion Chemical Ionization for the Determination of Polychlorinated n-Alkanes”, Analytical Chemistry, 75 (2003), pages 2 487 to 2 492) and by HPLC-MS (see Z. ZENCAK et al., “Chloride-Enhanced Atmospheric Pressure Chemical Ionization Mass Spectrometry of Polychlorinated n-Alkanes”, Rapid Communications in Mass Spectrometry, 18 (2004), pages 2 235 to 2 240). During the analysis by CG-MS, the chemical ionization is used to form ions and dichloromethane is used as the chlorine source (use of a methane/dichloromethane mix). This gas is obtained by mixing methane and dichloromethane that was previously put in gas form. The gas mix is then added at the transfer line using a tee. A system of valves controls the pressure of the added dichloromethane. It is coupled to a pumping system limiting the air inlet into the mass spectrometer through this transfer line. During the analysis by HPLC-MS, the authors used chloroform that they introduced either directly in the mobile phase before doing the chromatographic separation, or after chromatographic separation and before the eluant is added into the mass spectrometer using a post-column system. They never mentioned the possibility of introducing the additive into the gases used to supply the ionization chamber of the mass spectrometer. Apparently they did not get the idea of adapting the GC-MS analysis system for analysis by HPLC-MS, preferring to add chloroform directly in the mobile phase or through a post-column system.

Chlorinated adducts are frequently used to improve the detection of explosives. Thus, C. S. EVANS et al. (in “A Rapid and Efficient Mass Spectrometric Method for the Analysis of Explosives”, Rapid Communications in Mass Spectrometry, 16 (2002), pages 1 883 to 1 891) used a system for adding dichloromethane into the ionization chamber to improve the detection of explosives by injection of an additional gas containing dichloromethane vapor with an APCI source. Apparently the concentration of dichloromethane in the gas cannot be controlled, and all that can be controlled is the additional gas flow. With a mass spectrometer and an APCI interface in negative mode, direct injection of a solution of a volume of 1 μL containing quantities of RDX varying from 10 to 2.5 ng can be used to determine an instrumental detection limit of 5 ng, corresponding to a detectable concentration of 5 mg/L. This system was not used for ionization using the ESI interface. Furthermore, since the adduct is formed in solution before the charge separation phenomenon has taken place (see the article by N. B. CECH et al.), it is preferable if the additive is intimately mixed with products of interest so as to generate adducts with maximum yield.

After seeing these various studies, it was found that the formation of adducts has many advantages (identification, increased sensitivity, etc.) but that the different methods used for the introduction of additives introduce as many disadvantages (increased background noise, ionization suppression phenomenon, dirt accumulation in the ionization chamber, the mass spectrometer or the ion mobility spectrometer, contamination of the chromatographic system in the case of HPLC, etc.).

### PRESENTATION OF THE INVENTION

In order to overcome the problems mentioned above, it is proposed to add the additive into the spray gas in an API type ionization chamber (ESI, APCI or APPI) at a controlled concentration and at controlled times.

The purpose of the invention is to be able to facilitate the formation of adducts under optimum conditions by directly injecting a precise volume of additive into the spray gas. Therefore, the additive is vaporized in the spray gas, thus encouraging intimate contact between products of interest contained in the eluant and the additive. The additive is added without diluting the sample. Furthermore, there is no need for any treatment of the sample, which avoids manipulation and reduces risks of contamination. The system has a simple design and operates equally well with an APCI or APPI source and with an ESI source and therefore it can be used with a mass spectrometer or with an ion mobility spectrometer without needing to modify the apparatus. This system can be used for the detection of positive ions and negative ions. All that is necessary is to find the additive adapted to the selected detection mode. However, volatile or gaseous ionizable products have to be used (such as chloroform, le dichloromethane, formic acid, acetonitrile, etc.). When using a separation system (HPLC or electrophoresis) for making analyses of product mixes, regulation of the addition of the additive in time enables the introduction of the additive into the spray gas at the moment that the product of interest is ionized, so that ionization of other compounds is not inhibited. The addition of an additive regulated in concentration provides the means of only adding the quantity necessary to obtain a maximum signal. It is also possible to introduce several additives at the same time or alternately.

A first purpose of the invention is a process for introducing at least one additive for the analysis of at least one substance of interest using a mass spectrometer or an ion mobility spectrometer, the substance to be analyzed being transported by a solvent and injected into the analyzer of the spectrometer through an ionization interface at atmospheric pressure, into which a spray gas is also introduced, the additive being a compound designed to form adducts with the ionized substance, characterized in that the additive is introduced by adding spray gas before the spray gas is introduced into the ionization interface.

Several substances of interest may be in the form of a mix. The additive may be added into the spray gas at a concentration determined to encourage the formation of adducts under optimal conditions.

The additive may be in gas or liquid form.

At least two additives may be introduced simultaneously or one after the other.

A second purpose of the invention consists of an assembly for analysis of at least one substance of interest by a mass spectrometer or by an ion mobility spectrometer comprising an ionization interface at atmospheric pressure comprising means of introducing the substance to be analyzed transported by a solvent, the interface also including means of introducing a spray gas, the assembly also comprising means of introducing at least one additive so as to form adducts with the ionized substance, characterized in that the assembly comprises a system comprising means of adding said additive to the spray gas and means of transporting the resulting mix as far as the means of introducing the spray gas.

The system including the addition means may be a system enabling addition of an additive into the spray gas at a determined concentration to encourage the formation of adducts under optimum conditions.

The addition means may include a tee with a first input connected to means of supplying the spray gas, a second input connected to additive supply means, and an output connected to means of transporting the mix as far as the spray gas introduction means. The additive supply means may comprise at least one syringe activated by a syringe plunger. They may also comprise a reservoir containing the additive(s), and a pump for introduction of this (these) additive(s) with a given constant flow and at a pressure that can vary from 1 to several bars, to the addition means that are connected to the means of supplying the spray gas circulating under pressure.

### BRIEF DESCRIPTION OF THE FIGURES

The invention will be better understood and other advantages and special features will appear after reading the following description given as a non-limitative example with reference to the appended figures, wherein:

FIG. 1 shows an assembly with a non-automated electrospray ionization interface according to the invention, placed in front of the analyzer of a spectrometer;

FIG. 2 shows a non-automated APCI ionization interface assembly according to the invention placed in front of the analyzer of a spectrometer;

FIGS. 3A and 3B represent two operating states of an assembly with an automated API interface according to the invention;

FIG. 4 shows a diagram showing the variation of the chromatographic signal for 10 μg/L of HMX and RDX injected at different chloroform introduction flowrates into the spray gas with an electrospray interface;

FIG. 5 is a diagram showing calibration straight lines for HMX and RDX;

FIG. 6 is a diagram showing variation of the chromatographic signal for 10 μg/L of HMX and RDX injected at different chloroform introduction flowrates into the spray gas with an APCI interface;

FIG. 7 is a diagram showing calibration straight lines for HMX and RDX.

### DETAILED PRESENTATION OF PARTICULAR EMBODIMENTS

According to the invention, the additive (or additives) is (are) added into the spray gas, which assures intimate contact between the additive and the compounds to be analyzed. It is also possible to control the quantity of additive introduced directly by adjusting the flow from the syringe plunger or from the pump used to introduce the additive.

The additive added may be controlled in time and this additive can be injected only when its presence is necessary either by manual control, or using an automated device (continuous or discontinuous mode). It is also possible to inject several additives either simultaneously or alternately.

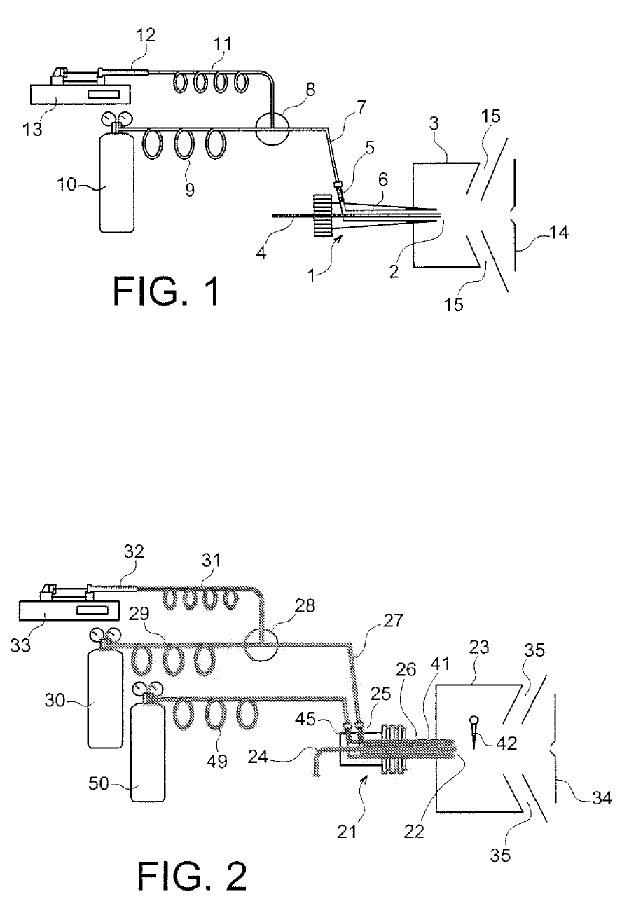

FIG. 1 represents an assembly with a non-automated electrospray ionization interface according to the invention, located in front of the analyzer of a spectrometer.

The assembly comprises an electrospray nozzle 1, the output 2 of which opens up in the ionization chamber 3. A capillary 4 is placed in the nozzle 1 along the principal axis of the nozzle. It transports the eluant containing the sample to be analyzed as far as the exit from the nozzle. A fluid connection 5 provides access to the annular space 6 between the capillary 4 and the inside wall of the nozzle 1. A tube 7 connects the connection 5 to the output from a tee 8. One of the inputs to the tee is connected to a pipe 9 connected onto a spray gas cylinder 10. The other input of the tee is connected to a pipe 11 connected to the needle of a syringe 12 fixed onto a syringe plunger 13.

The ionization chamber 3 is arranged facing the input 14 of the analyzer, the nozzle 1 being aligned with the input to the analyzer. An output 15 is provided between the analyzer input and the ionization chamber to evacuate products not wanted for the analyzer, by pumping.

The additive is contained in the syringe 12. The nozzle 1 is brought to a high electrical potential relative to a counter-electrode located close to the analyzer input. The eluant added through the capillary 4 is then sprayed into the ionization chamber 3 where it is in intimate contact with the additive transported by the spray gas in gaseous form. The ions formed are accelerated by the potential difference between the electrospray nozzle and the analyzer input and are subjected to action of a drying gas enabling good solvent extraction.

FIG. 2 shows an assembly with a non-automated APCI ionization interface according to the invention, placed in front of the analyzer of a spectrometer.

The assembly comprises an APCI nozzle 21, for which the output 22 opens up into the ionization chamber 23. A capillary 24 is placed in the nozzle 21 along the principal axis of the nozzle. It transports the eluant containing the sample to be analyzed as far as the exit from the nozzle. A first fluid connection 25 provides access to the annular space 26 between the capillary 24 and the internal wall of a tube 41 surrounding the capillary 24. A tube 27 connects the connection 25 to the output from a tee 28. One of the inputs to the tee is connected to a pipe 29 connected to a spray gas cylinder 30. The other input of the tee is connected to a pipe 31 connected to the needle of a syringe 32 fixed onto a syringe plunger 33.

A second fluid connection 45 provides access to the annular space between the tube 41 and the inside wall of the nozzle 21. A pipe 49 connects the connection 45 to a cylinder 50 containing an auxiliary gas, for example nitrogen or air.

The ionization chamber 23 is arranged to be facing the input 34 of the analyzer, the nozzle 21 being aligned with the analyzer input. An output 35 is provided between the analyzer input and the ionization chamber, through which products not required by the analyzer are evacuated by pumping.

The auxiliary gas output from the cylinder 50 is added when the eluant arrives, introduced into the ionization chamber 23 through the capillary 24. A corona needle 42 is placed at the output from the nozzle. The needle 42 ionizes molecules by a corona discharge. Ions are desolvated by the action of a drying gas, and are introduced into the analyzer. The system for introduction of the additive into the spray gas is identical to the case shown in FIG. 1.

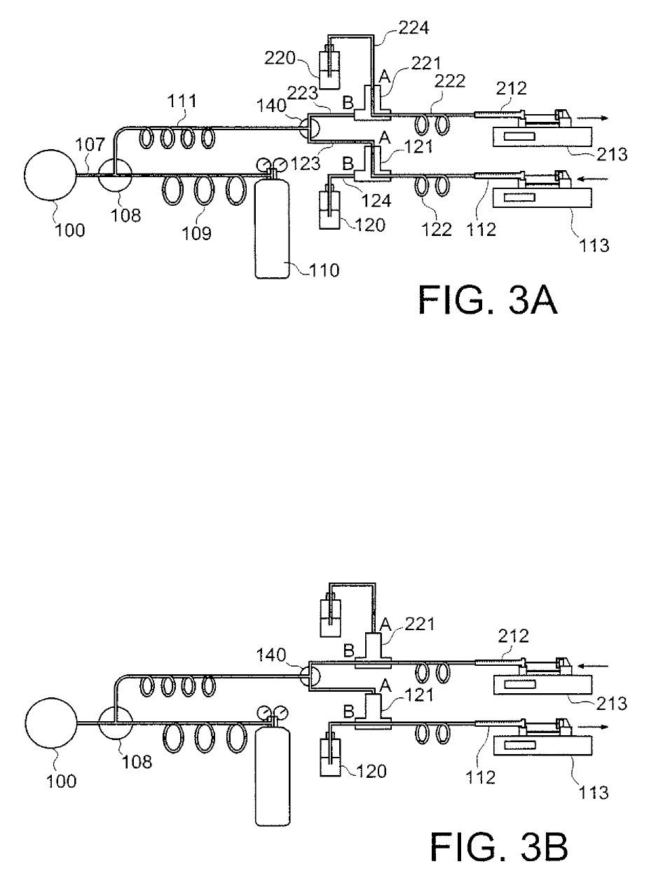

FIGS. 3A and 3B show two operating states of an automated assembly with an API interface according to the invention. In these figures, only the additive introduction system is shown. The remainder of the interface assembly denoted as global reference 100 may include an ESI interface (see FIG. 1) or an APCI interface (see FIG. 2).

The system includes a tee 108, the output of which is connected to the nozzle of the ionization interface through a tube 107. One of the inputs to the tee 108 is connected to a spray gas cylinder 110 through a pipe 109. The other input to the tee 108 is connected to the output from a tee 140 through a pipe 111. The tee 140 has two inputs each enabling the introduction of an additive: a first additive contained in the reservoir 120 and the second additive contained in the reservoir 220.

The first additive line corresponding to the first additive comprises a solenoid valve 121 putting a first end of a pipe 122 into fluid communication with the first end of a pipe 123 (position A), or with a first end of a pipe 124 (position B). The second end of the pipe 123 is connected to a first input to the tee 140. The second end of the pipe 124 dips into the additive contained in the reservoir 120. The second end of the pipe 122 is connected to the syringe 112 of a pump 113.

The second line of additives corresponding to the second additive includes a solenoid valve 221 for putting a first end of a pipe 222 into fluidic communication with a first end of the pipe 224 (position A), or with a first end of a pipe 223 (position B). The second end of the pipe 223 is connected to a second input of the tee 140. The second end of the tube 224 dips into the additive contained in the reservoir 220. The second end of the pipe 222 is connected to the syringe 212 of a pump 213.

When the solenoid valves 121 and 221 are in position A, the pump 213 draws off additive from the reservoir 220 while the pump 113 introduces the additive contained in the syringe 112 into the spray gas through tees 140 and 108. In the case of a system using a separative part, a timer (not shown in FIGS. 3A and 3B) connected to the injection system is used to trigger introduction of the additive into the spray gas at the beginning of the analysis or after a determined latency time and stops its introduction at the required time. When the additive contained in the syringe 112 has been added into the spray system through tees 140 and 108, the solenoid valves 221 and 121 switch over to position B (see FIG. 3B). The pump 212 then outputs the additive contained in the syringe 212 into the spray gas while the pump 113 draws off the additive from the reservoir 120.

Therefore, this system can work continuously, regulated in time and in concentration and it can be used to introduce one or more additives (depending on the additives introduced into reservoirs 120 and 220) either simultaneously or alternately. Simultaneous addition of additives enables an improvement to the detection of different substances either by generating specific adducts or by facilitating the formation of a single ionic species. However, introducing additives alternately can improve the detection of substances eluated in sequence for which specific and different additives would be required, and which would cause inhibition phenomena if they were introduced simultaneously.

For example, the invention was applied to detection and identification of nitramines (HMX and RDX) using the HPLC-MS method. These two compounds form part of the class of organic explosives.

Liquid chromatography coupled with mass spectrometry with an API interface in negative mode is used for the analysis of nitramines see the article by Y. YINON et al. mentioned above). Negative mode is most appropriate because these compounds are deficient in electrons. RDX and HMX are thermolabile compounds. RDX is known for decomposing starting from 230° C. and HMX from about 280° C. Further information about this subject is given by A. GAPEEV et al., <<Liquid Chromatography/Mass Spectrometric Analysis of Explosives: RDX Adduct Ions>>, Rapid Communications in Mass Spectrometry, 17 (2003), pages 943 to 948. These products release nitrogen compounds during degradation and in the absence of additives, leading to the formation of several adducts.

This phenomenon, dependant on the quantity of degraded product, creates problems during quantitative analyses. Furthermore, the corresponding signals are not very intense, which induces a high detection limit (several tens of μg/L).

The ability of nitramines to form adducts with chlorine was used to encourage their detection (see also article by Y. YINON et al.). The addition of a known and constant quantity of a chlorine source provides a means of eliminating adducts formed in the presence of NO₂ to be replaced by chlorinated adducts only, thus very significantly increasing the sensitivity of the detector to nitramines.

The other advantage of these chlorine adducts is their isotopic signature. The natural relative abundance of chlorine isotopes (³⁵Cl and ³⁷Cl) confirms the presence of the compound by searching for [M+³⁵Cl]⁻ and [M+³⁷Cl]⁻ ions.

Mass spectra corresponding to HMX and RDX in the presence or absence of chlorinated additives then consist of the ions mentioned in table 1, that summarizes ions detected during analysis of HMX and RDX by ESI-MS or ACPI-MS.

TABLE 1

| | Without chlorinated additive | With chlorinated additive |
|---|---|---|
| | Relative | Relative |
| | abundance | abundance |
| | Observed ions | Observed ions |
| Compounds | (mass/charge) | (mass/charge) |
| RDX | [M − H]⁻ (221) | [M + ³⁵Cl]⁻ (257) |
| | [M + NO₂ − H]⁻ (267) | 100 |
| | majority | [M + ³⁷Cl]⁻ (259) 33 |
| | [M− + NNO₂ − H]⁻ (281) | |
| HMX | [M − H]⁻ (295) | [M + ³⁵Cl]⁻ (331) 100 |
| | [M + NO₂ − H]⁻ (341) | [M + ³⁷Cl]⁻ (333) 33 |
| | majority | |
| | [M− + NNO₂ − H]⁻ (355) | |

In the case of an ion mobility spectrometer equipped with an API ionization source, the presence of an additive (such as dichloromethane) can be used to obtain stable and intense [RDX+X]⁻ ions, leading to low detection limits. The invention is perfectly usable for this type of detector provided with an API type ionization source. The same is true when a mass spectrometer is couple to the ion mobility spectrometer equipped with an API type ionization source. The gain in terms of the detection sensitivity and ease of use is obvious.

### Example 1

### Detection and Identification of HMX and RDX by HPLC-MS with Electrospray Interface

The chromatographic system used consists of two pumps operating in tandem, outputting a binary mix of methanol and ultra pure water, a degasser (to eliminate gases dissolved in the mobile phase), an automatic sample changer, a chromatographic column and an automatic injection loop. The system is connected to a <<triple quadripole>> type mass spectrometer equipped with an electrospray interface (made by VARIAN type 1200L). Detection takes place in negative detection mode, and only [M+³⁵Cl]⁻ ions are analyzed. Synthetic air (79% nitrogen and 21% oxygen) is then used as the spray gas. Nitrogen could also be used.

Table 2 contains chromatographic conditions used for detection of HMX and RDX by HPLC-MS with an ESI interface.

TABLE 2

| | |
|---|---|
| Analytic column | |
| Type: | C18 - inverted phase |
| | polarity |
| Length: | 25 cm |
| Inside diameter: | 2 mm |
| Support | |
| Type: | Grafted silica |
| Particle size (diameter): | 5 μm |
| Mobile phase | |
| Composition: | Water/methanol - 50/50 |
| | by volume |
| Flow: | 0.2 mL · min⁻¹ |
| Solvent gradient: | None |
| Injection of the sample | |
| Loop volume: | 100 μL |
| Injection type: | Automatic - Automatic |
| | sample changer cooled to 4° C. |

Chloroform was chosen as the chlorinated additive for the detection of nitramines. It is introduced in a 1 mL syringe fixed on the syringe plunger. Operation is started manually. The flow is adjusted to obtain the maximum signal while consuming the consuming the minimum amount of chlorinated solvent. A solution with a concentration equal to 10 μg/L of HMX and RDX was prepared to determine the optimum flow. This solution was injected at the same time as chloroform into the spray gas with increasing injection flows. The response of the detector increases as the injection flow increases until a plateau is reached. It is found that the optimum chloroform flowrate is 10 μL/min. The response of the detector will be constant at this flowrate, even if small fluctuations in injection flow take place. The chloroform flow in the spray gas was fixed at 10 μL/min in all these analyses with an electrospray interface.

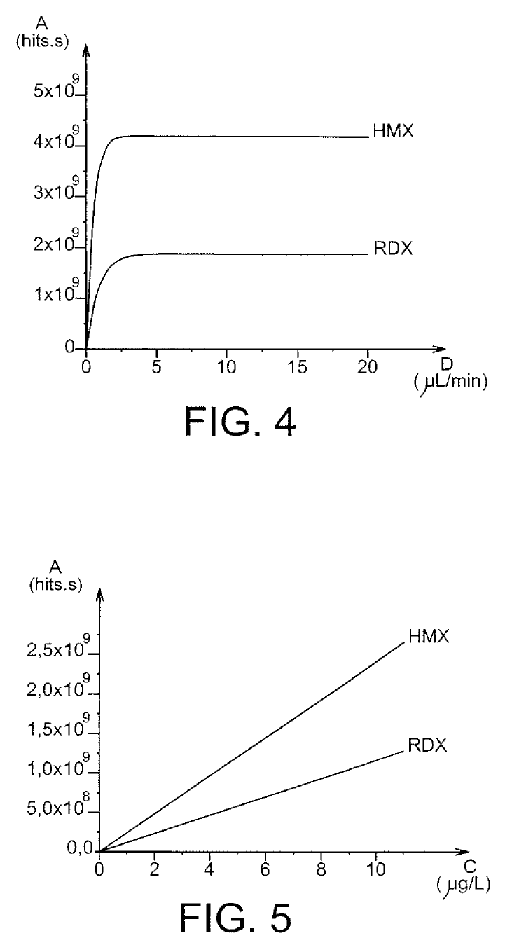

FIG. 4 shows the variation of the chromatographic signal for 10 μg/L of HMX and RDX injected at different chloroform introduction flowrates into the spray gas. The abscissa axis corresponds to the chloroform flowrate D in μL/min and the ordinate axis corresponds to the area A of the corresponding peak in hits.s.

Signal stability was verified in the presence of chloroform. This was done preparing an aqueous solution containing 10 μg/L of HMX and RDX. This solution is prepared starting from standard commercial solutions of HMX and RDX with a concentration equal to 1 mg/mL in acetonitrile. By diluting with ultra pure water, the solution obtained has a concentration of 10 μg/L for each nitramine. This solution is injected several times. Chloroform is introduced into the spray gas according to the invention, during these various injections. The detector signal is stable during different injections (the percent relative standard deviation is less than 5%). By measuring ionic intensities corresponding to the [HMX−H]⁻, [HMX+NO₂—H]⁻, [HMX+NNO₂—H]⁻, [HMX+³⁵Cl]⁻ and [HMX+³⁷Cl]⁻, it is found that only the [HMX+Cl]⁻ ions are detected. At the same time, by measuring ionic intensities corresponding to the [RDX-H]⁻, [RDX], [RDX+NO₂—H]⁻, [RDX+NO₂]⁻, [RDX+³⁵Cl]⁻ and [RDX+³⁷Cl]⁻ ions, it is found that only the [RDX+Cl]⁻ adducts are detected.

Standard solutions with concentrations equal to 2, 5 and 10 μg/L were then prepared so as to determine detection limits for each nitramine by analyzing the [HMX+³⁵Cl]⁻ and [RDX+³⁵Cl]⁻ ions.

FIG. 5 shows a diagram representing calibration straight-lines for HMX (R²=0.9936) and for RDX (R²=0.9954).

The detection limits obtained are equal to 0.02 μg/L for HMX and 0.02 μg/L for RDX. Considering the experimental protocol used, the quantity of detectable material is 2 pg for HMX and 2 pg for RDX.

### Example 2

### Detection and Identification of HMX and RDX by HPLC-MS with an APCI Interface

In this example, the chromatographic system is exactly the same as that used in example 1, except for the chromatographic column used. In the case of an APCI interface, the optimum flow is between 0.7 and 1 mL·min⁻¹, while the optimum flow for an electrospray interface varies from 100 to 300 μL·min⁻¹. These flow differences mean that the inside diameter of the chromatographic column in the case of an electrospray interfaces is generally less than the inside diameter of a column used with an APCI interface. In this case, columns with an inside diameter 4.6 mm were chosen when the APCI interface was used, and with an inside diameter of 2 mm when the electrospray interface was used. In the same way as above, detection is done in negative detection mode and only the [M+³⁵Cl]⁻ ions are analyzed. Synthetic air (79% of nitrogen and 21% oxygen) is used as the spray gas and nitrogen is used as the drying gas.

Table 3 contains the chromatographic conditions used for detection of HMX and RDX by HPLC-MS with an APCI interface.

TABLE 3

| | |
|---|---|
| Analytic column | |
| Type: | C18 - inverted phase polarity |
| Length: | 25 cm |
| Inside diameter: | 4.6 mm |
| Support | |
| Type: | Grafted silica |
| Particle size (diameter): | 5 μm |
| Mobile phase | |
| Composition: | Water/methanol - 70/30 by volume |
| Flow: | 0.7 mL · min⁻¹ |
| Solvent gradient: | None |
| Sample injection | |
| Loop volume: | 100 μL |
| Injection type: | Automatic - Automatic sample |
| | changer cooled to 4° C. |

Chloroform was once again used as the chlorinated additive for detection of nitramines. It is added in a 1 mL syringe fixed to the syringe plunger. Operation is also started manually in this case. The flow is adjusted to obtain the maximum signal while consuming the minimum amount of chlorinated solvent. A solution with a concentration of 10 μg/L of HMX and RDX was prepared to determine the optimum flow.

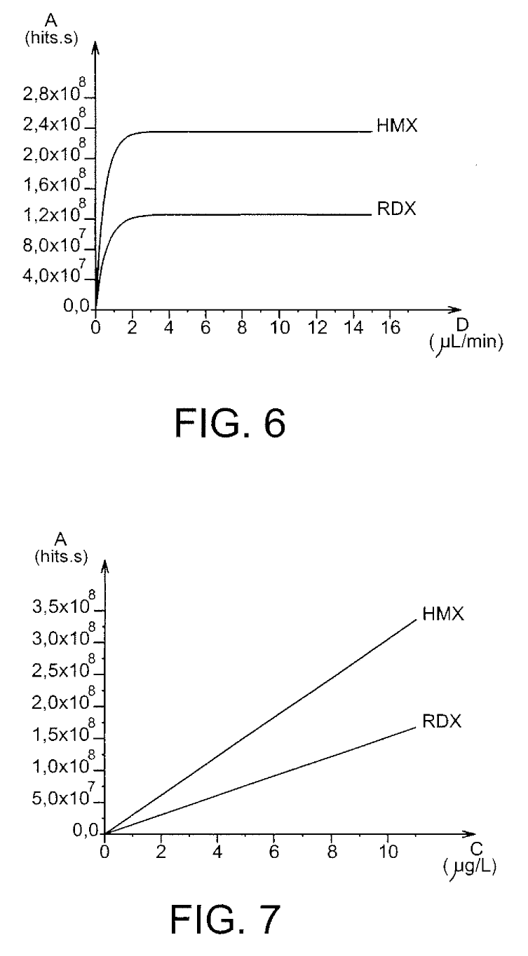

FIG. 6 represents the variation of the chromatographic signal for 10 μg/L of HMX and RDX injected at different chloroform introduction flowrates into the spray gas with an APCI interface.

This solution was injected by introducing chloroform into the spray gas at the same time with increasing flowrates. The response of the detector increases as the injection flowrate of chloroform increases, until reaching a plateau. It is found that in this case the optimum chloroform flow is 10 μL/min. At this flowrate, the response of the detector will be constant even if small fluctuations in the injection flow take place.

The chloroform flowrate in the spray gas was fixed at 10 μL/min throughout all these analyses with the APCI interface. Standard solutions with concentrations equal to 2, 5 and 10 μg/L were then prepared so as to determine detection limits for each nitramine by analyzing the [HMX+³⁵Cl]⁻ and [RDX+³⁵Cl]⁻ ions.

FIG. 7 shows a diagram representing calibration straight lines for HMX (R²=0.9988) and RDX (R²=0.9996).

The detection limits obtained are equal to 0.17 μg/L for HMX and 0.16 μg/L for RDX. Considering the experimental protocol used (100 μL injection loop), the detectable material quantity is 17 pg for HMX and 16 pg for RDX.

### INVENTION APPLICATIONS

Detection and identification of various compounds may be very much improved by this invention. Thus, a precise volume of additive can be injected directly into the spray gas in which it is vaporized, thus facilitating intimate contact between products of interest and the additive, which enables formation of the adduct under optimum conditions.

The additive was added into the spray gas without diluting the sample, unlike what happens with a post-column system.

The system is equally applicable with an APCI source and with an ESI source, without it being necessary to modify the apparatus (valid for all types of mass spectrometers and ion mobility spectrometers provided with an API interface). Consequently, the system can be fully automated and programmed.

This system can be used for detection of positive ions and negative ions. All that is necessary is to find the additive adapted to the selected detection mode. However, ionizable and volatile products have to be used (such as chloroform, dichloromethane, formic acid, acetonitrile, etc.).

Regulation in time of the amount of additive added during analyses of product mixes using a system that enables separation of said products (HPLC, electrophoresis, etc.), enables introduction of the additive into the spray gas at the time of ionization of the product of interest in order to avoid inhibiting ionization of other compounds. It is impossible to do the same thing when the additive is introduced in the mobile phase.

The addition of additives regulated in concentration provides a means of introducing only the quantity necessary to obtain a maximum signal.

The addition of salts into the eluant in order to form adducts frequently leads to ionization suppression phenomena and dirt accumulation on the instrumentation (ionization chamber and mass spectrometer). These salts can also inhibit ionization of other compounds. Furthermore in the case of a chromatographic system, they strongly contaminate the equipment (pump, degasser and column). The invention provides a means of eliminating this negative aspect.

The invention can also be used for the analysis of different substances, for example including pesticides, sugars, triacylglycerols, aliphatic and aromatic carboxylic acids, amides, amino acids, aromatic amines, phenols, fullerenes, polychlorinated alkanes and non-ionic surfactants.

1. Process for introducing at least one additive for the analysis of at least one substance of interest using a mass spectrometer or an ion mobility spectrometer providing a corresponding detection signal, the substance to be analyzed being transported by a solvent and injected into the analyzer of the spectrometer through an ionization interface at atmospheric pressure, into which a spray gas is also introduced, the additive being a compound designed to form adducts with the ionized substance, the introduction of the additive being realized by addition to the spray gas before the introduction of the spray gas in the ionization interface, wherein the additive is added into the spray gas at a controlled concentration and at controlled times to encourage the formation of adducts under optimal conditions, that is to obtain a maximum detection signal and to consume a minimum of additive.

2. Process set forth in claim 1, wherein the additive is in gas or liquid form.

3. Process set forth in claim 1, wherein at least two additives are introduced simultaneously.

4. Process set forth in claim 1, wherein at least two additives are introduced one after the other.

5. Assembly for analysis of at least one substance of interest by a mass spectrometer or by an ion mobility spectrometer providing a corresponding detection signal, comprising an ionization interface at atmospheric pressure comprising means of introducing the substance to be analyzed transported by a solvent, the interface also including means of introducing a spray gas, the assembly also comprising means of introducing at least one additive so as to form adducts with the ionized substance, the assembly comprising a system comprising addition means for adding said additive to the spray gas and means of transporting the resulting mix as far as the means of introducing the spray gas, wherein the system comprising the addition means is a system enabling addition of additive into the spray gas at a controlled concentration and at controlled times to encourage the formation of adducts under optimum conditions, that is to obtain a maximum detection signal and to consume a minimum of additive.

6. Assembly set forth in claim 5, wherein the addition means include a tee with a first input connected to means of supplying the spray gas, a second input connected to additive supply means, and an output connected to means of transporting the mix as far as the spray gas introduction means.

7. Assembly set forth in claim 6, wherein the additive supply means comprise at least one syringe activated by a syringe plunger.

8. Assembly set forth in claim 6, wherein the additive supply means comprise one syringe activated by a pump.
